(19) United States
(12) Patent Application Publication
(10) Pub. No.: US 2022/0009135 A1
(43) Pub. Date: Jan. 13, 2022

(54) STACKED WORKPIECE MOLDING DEVICE

(71) Applicant: HONDA MOTOR CO., LTD., Tokyo (JP)

(72) Inventors: Akira Taguchi, Tochigi (JP); Hiroaki Iwanishi, Tochigi (JP); Michinobu Sato, Tochigi (JP); Hikaru Kurokawa, Tochigi (JP); Takashi Iino, Tochigi (JP); Yusuke Kato, Tochigi (JP); Takashi Abe, Tochigi (JP)

(21) Appl. No.: 17/424,718

(22) PCT Filed: Nov. 1, 2019
(86) PCT No.: PCT/JP2019/043122

§ 371 Date: Jul. 21, 2021

(30) Foreign Application Priority Data
Jan. 23, 2019 (JP) 2019-009244

(51) Int. Cl. B29C 43/36; B29C 43/02; B29C 43/58; B29C 33/18; B21D 26/021

(52) U.S. Cl. CPC B29C 43/36; B29C 43/021; B29C 2043/023; B29C 33/18; B21D 26/021; B29C 43/58

(57) ABSTRACT

A stacked workpiece molding device 1 includes: a first mold 20 configured to suck and hold a workpiece body 42; and a second mold 30 having on an inner surface a pattern that can be transferred to a surface of a sheet material 44 stacked on the workpiece body 42 and press the sheet material 44 against the workpiece body 42. The inner surface of the second mold 30 includes a groove portion 31 that is positioned at a peripheral edge portion of the workpiece body 42, the second mold 30 includes a through-hole 32 extending to open into the groove portions 31, the through-hole 32 is connected to a first suction device 51 that sucks the sheet material 44, and the first mold 20 includes a suction hole 22 for sucking the workpiece body 42, and the suction hole 22 is connected to a second suction device 52.

### TECHNICAL FIELD

The present invention relates to a stacked workpiece molding device.

### BACKGROUND ART

Conventionally, there has been known a stacked workpiece molding device that molds a stacked workpiece including a workpiece body and a sheet material stacked on the workpiece body by using a first mold for sucking and holding the workpiece body (see, for example, JPH07-24909 A).

In Patent Literature 1, in order to prevent the sheet material from being drawn into a clearance recess formed in a central portion of the workpiece body and being torn, the clearance recess is closed by a shutter.

Further, since the degree of freedom in layout of the workpiece body is restricted when the shutter covering the clearance recess is provided, there is also known what is provided with a suction device that is positioned in the clearance recess formed in the central portion of the workpiece body and sucks the sheet material in a direction away from the workpiece body (see, for example, JP 2000-218688 A).

### CITATION LIST

### Patent Literature

Patent Literature 1: JPH07-24909 A

Patent Literature 2: JP 2000-218688 A

### SUMMARY OF INVENTION

### Technical Problem

In the stacked workpiece molding device of Patent Literature 1, in cases where a second mold having on an inner surface a pattern that can be transferred to the surface of the sheet material is used, when the sheet material is sucked by the second mold and the pattern is transferred and then the sheet material is stuck to the workpiece body such that the first mold, which sucks the workpiece body, overlaps with the second mold, it is conceivable to cause a fluid such as air to be ejected from the second mold in order to facilitate separation of the sheet material from the second mold.

In this case, the suction device that is positioned in the clearance recess formed in the central portion of the workpiece body and sucks the sheet material in a direction away from the workpiece body as in Patent Literature 1 cannot be provided. Therefore, in order to improve the degree of freedom in layout of the workpiece body, it is conceivable to arrange an insert in the clearance recess.

Further, it is conceivable to provide a shutter device at a peripheral edge of the workpiece body that does not affect the degree of freedom in layout of the workpiece body to prevent the sheet material from sticking to a place where the sheet material is not to be stuck at the peripheral edge of the workpiece body.

However, when the shutter device is provided at the peripheral edge of the workpiece body, there is a problem that since the sheet material is gripped by a clamp arranged outside the shutter device, it is necessary to prepare a sheet material that is large because of the shutter device, the installation cost of the shutter device and the maintenance cost of the shutter device are increased, and the costs cannot be suppressed.

In view of the above, it is an object of the present invention to provide a stacked workpiece molding device that can suppress the costs.

### Solution to Problem

[1] In order to achieve the above object, the present invention is a stacked workpiece molding device including:

a first mold configured to suck and hold a workpiece body; and

a second mold configured to have on an inner surface a pattern that can be transferred to a surface of a sheet material stacked on the workpiece body and press the sheet material against the workpiece body, in which

the inner surface of the second mold includes a groove portion that is positioned at a peripheral edge portion of the workpiece body,

the second mold includes a through-hole extending to open into the groove portion,

the through-hole is connected to a first suction device that sucks the sheet material,

the first mold includes a suction hole for sucking the workpiece body, and

the suction hole is connected to a second suction device.

According to the present invention, since the sheet material at the peripheral edge of the workpiece body is sucked by the first suction device, it is not necessary to arrange the shutter device at the peripheral edge of the workpiece body. Thus, the stacked workpiece molding device can be provided in which the stacked workpiece can be molded using a sheet material that is small because the shutter device can be omitted, the manufacturing cost of the stacked workpiece can be suppressed, and the cost of the molding device itself can also be suppressed.

Further, since the through-hole is opened in the groove portion provided on the inner surface of the second mold, a wide area where the groove portion is provided can be sucked by suction by the first suction device through one through-hole, and the number of through-holes per unit area can be reduced.

[2] Further, in the present invention, it is preferable that the groove portion is provided in a net shape. With this configuration, a wider area can be sucked by one through-hole as compared with the case where the groove portion is formed in a straight shape, and the number of through-holes per unit area can be reduced.

[3, 4] Further, in the present invention, it is preferable to include: a control unit configured to set suction forces of the first suction device and the second suction device, in which

the control unit sets the suction force of the first suction device to be stronger than the suction force of the second suction device in a bonding step of bonding the sheet material to the workpiece body.

According to the present invention, the sheet material of the unbonded portion can be appropriately drawn to the second mold side.

### BRIEF DESCRIPTION OF DRAWINGS

FIG. 1 is an explanatory view schematically illustrating an embodiment of a stacked workpiece molding device of the present invention.

FIG. 2 is an explanatory view illustrating a first mold and a workpiece body of the present embodiment.

FIG. 3 is an enlarged explanatory view illustrating a through-hole of the present embodiment.

FIG. 4 is an explanatory view illustrating the suction force of a bonding step of the present embodiment.

FIG. 5 is an explanatory view illustrating a workpiece-side projection of the present embodiment.

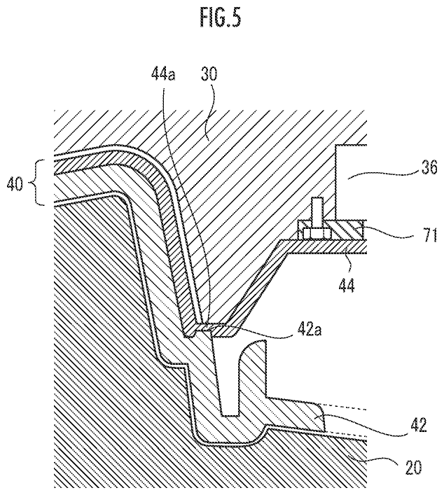

FIG. 6 is an explanatory view illustrating a net-shaped groove portion and a through-hole of the present embodiment.

FIG. 7 is an enlarged explanatory view illustrating a groove portion and a through-hole of the present embodiment.

FIG. 8 is an enlarged explanatory view illustrating a groove portion and a sheet material of the present embodiment.

FIG. 9 is an explanatory view schematically illustrating a shutter device as a comparative example.

### DESCRIPTION OF EMBODIMENTS

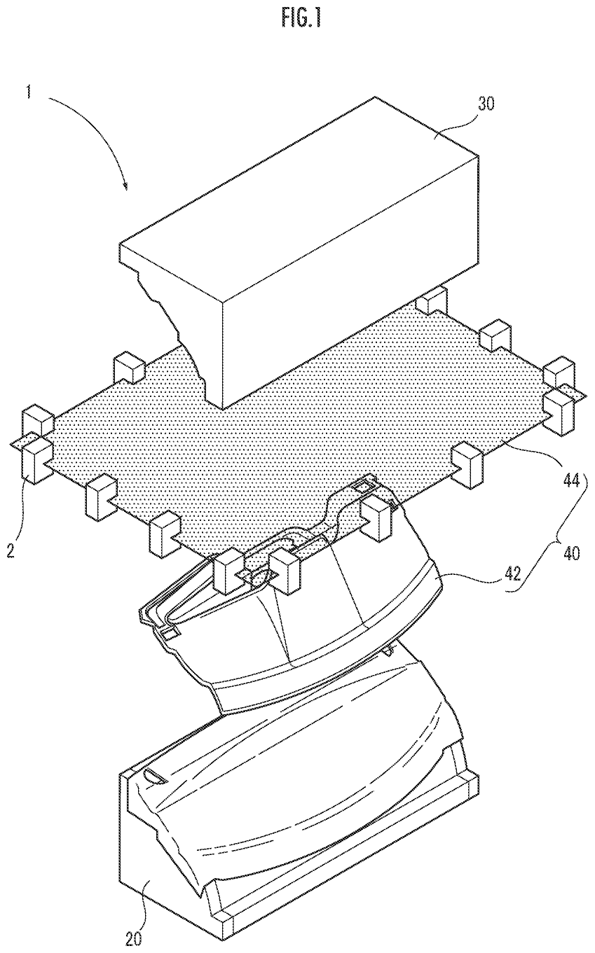

Embodiments of the stacked workpiece molding device of the present invention will be described with reference to the drawings. Referring to FIG. 1, a stacked workpiece molding device 1 of the present embodiment includes a first mold 20 and a second mold 30. A stacked workpiece 40 such as an instrument panel molded by the stacked workpiece molding device 1 includes a workpiece body 42 and a sheet material 44 stacked on the workpiece body 42.

The stacked workpiece molding device 1 includes a plurality of clamps 2 for gripping the peripheral edge of the sheet material 44.

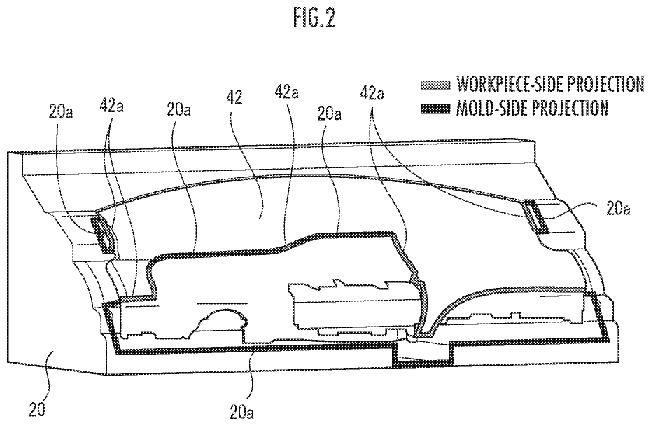

FIG. 2 illustrates a state in which the workpiece body 42 is placed on the first mold 20.

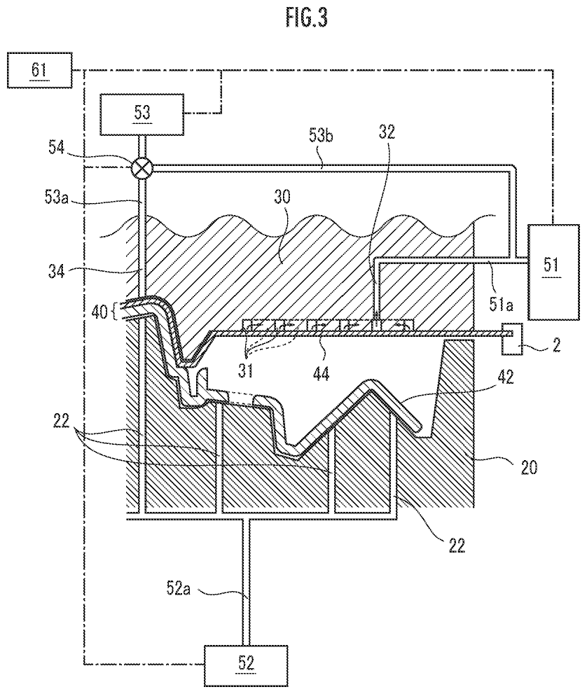

As illustrated in FIG. 3, the first mold 20 includes a plurality of suction holes 22 opened to a placement surface on which the workpiece body 42 is placed. On the inner surface of the second mold 30, a pattern including a recess and a protrusion such as embossing or satin to be transferred to the surface of the sheet material 44 is formed.

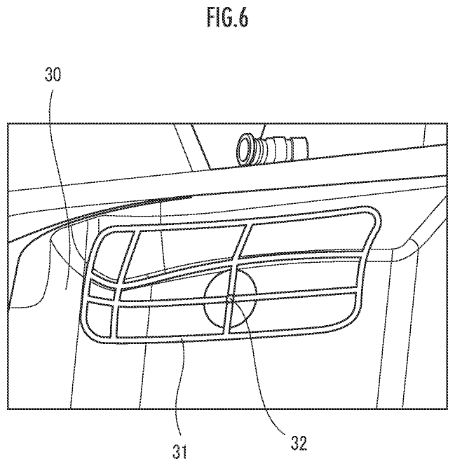

The second mold 30 includes a plurality of groove portions 31 having a net shape (see FIG. 6) positioned at a peripheral edge portion of the workpiece body 42 when the second mold 30 is overlapped with the first mold 20 across the workpiece body 42 and the sheet material 44. Further, in the second mold 30, through-holes 32 extending to open into the groove portions 31 are provided for the respective groove portions 31 one by one.

Further, the second mold 30 includes a plurality of ejection holes 34 extending to be opened at the position of a central portion of the workpiece body 42, which is a part excluding the peripheral edge of the workpiece body 42.

The through-holes 32 are connected to a first suction device 51 for sucking the sheet material 44 via a first connection pipe 51a. The suction holes 22 are connected to a second suction device 52 for sucking the workpiece body 42 via a second connection pipe 52a. The ejection holes 34 are connected to a gas supply device 53 for supplying a gas such as air via a third connection pipe 53a.

The first connection pipe 51a and the third connection pipe 53a are connected to a bypass path 53b. A connection portion between the third connection pipe 53a and the bypass path 53b includes a flow path switching valve 54. The flow path switching valve 54 is configured to be switchable between two states: an “ejectable state” in which the gas supply device 53 is connected to the ejection holes 34 via the third connection pipe 53a and the connection of the ejection holes 34 to the first suction device 51 via the bypass path 53b is disconnected; and a “suckable state” in which the first suction device 51 is connected to the ejection holes 34 via the third connection pipe 53a, the bypass path 53b, and the first connection pipe 51a and the connection between the ejection holes 34 and the gas supply device 53 is disconnected.

Further, referring to FIG. 2, the first mold 20 and the workpiece body 42 include respectively a mold-side projection 20a and a workpiece-side projection 42a projecting toward the second mold 30 and extending along the outer edge of a bonding region of the sheet material 44 so as to surround the plurality of through-holes 32.

Assuming that the mold-side projection 20a and the workpiece-side projection 42a are not provided, when the sheet material 44 is separated from the second mold 30 by supplying the gas to the surface of the sheet material 44 from the gas supply device 53 through the ejection holes 34 in the bonding step of bonding the sheet material 44 to the workpiece body 42, when the gas supplied to the surface of the sheet material 44 flows directly into the through-holes 32 and is sucked by the first suction device 51, the sheet material 44 suction performance by the first suction device 51 deteriorates.

Therefore, in the present embodiment, as described above, when the mold-side projection 20a and the workpiece-side projection 42a are provided so as to surround the through-holes 32, it is possible to suppress or prevent the gas supplied from the gas supply device 53 to the surface of the sheet material 44 from flowing into the through-holes 32, and it is possible to suppress or prevent the deterioration of the sheet material 44 suction performance by the first suction device 51. Note that, instead of the mold-side projection 20a and the workpiece-side projection 42a, the mold-side projection may be provided on the second mold 30.

As illustrated in FIG. 3, the stacked workpiece molding device 1 includes a control unit 61 that controls the first suction device 51, the second suction device 52, the gas supply device 53, and the flow path switching valve 54. The control unit 61 is an electronic control unit including a CPU, a memory, and the like, and controls the first suction device 51, the second suction device 52, the gas supply device 53, and the flow path switching valve 54 by executing a control program held in a storage unit such as the memory by using the CPU and transmitting an instruction signal.

Next, the stacked workpiece molding method using the stacked workpiece molding device 1 will be described.

First, the first mold 20 and the second mold 30 are brought into an open state, and the workpiece body 42 is placed on the first mold 20. Then, the sheet material 44 gripped by the clamps 2 is arranged between the workpiece body 42 and the second mold 30. Then, the first mold 20 and the second mold 30 are brought closer to each other into a closed state.

Next, the control unit 61 switches the flow path switching valve 54 to the “suckable state” (the state in which the first suction device 51 is connected to the ejection holes 34 via the third connection pipe 53a, the bypass path 53b, and the first connection pipe 51a and the connection between the ejection holes 34 and the gas supply device 53 is disconnected) so that the sheet material 44 is sucked by the first suction device 51 and stuck to the inner surface of the second mold 30 via the groove portions 31, the through-holes 32, and the ejection holes 34. Thus, the pattern formed on the inner surface of the second mold 30 can be transferred to the surface of the sheet material 44 (transfer step).

Next, in a state where an adhesive is applied to the workpiece body 42 or the sheet material 44, the sheet material 44 is pressed against the workpiece body 42 and bonded by the suction force of the second suction device 52 (bonding step).

Here, the sheet material 44 is not bonded to the entire surface of the workpiece body 42, but is bonded only to a portion exposed when an automobile or the like is assembled, and unbonded to a portion such as the peripheral edge hidden by other components during assembly to prevent assembly failure, and only the bonded portion is left and the non-bonded portion is cut and discarded.

Then, in the bonding step, the control unit 61 switches the flow path switching valve 54 to the “ejectable state” (the state in which the gas supply device 53 is connected to the ejection holes 34 via the third connection pipe 53a and the connection of the ejection holes 34 to the first suction device 51 via the bypass path 53b is disconnected) so that the gas supply device 53 supplies the gas through the ejection holes 34 between the sheet material 44 and the second mold 30 to separate the sheet material 44 from the second mold 30.

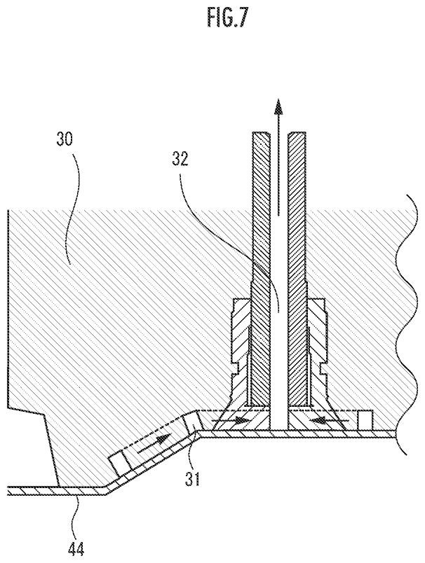

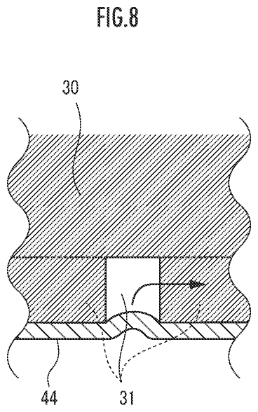

Further, as illustrated in an enlarged scale in FIG. 7, the control unit 61 causes the first suction device 51 to suck the portion of the sheet material 44, which is not bonded to the workpiece body 42, to the second mold 30 via the groove portions 31 and the through-holes 32 by sucking the sheet material 44 to the second mold 30 side. At this time, as illustrated in FIG. 8 by enlarging the groove portions 31, even when the sheet material 44 is stuck to the inner surface of the second mold 30, the groove portions 31 can secure a gap with respect to the sheet material 44, and the overall suction force of the groove portions 31 can be properly maintained.

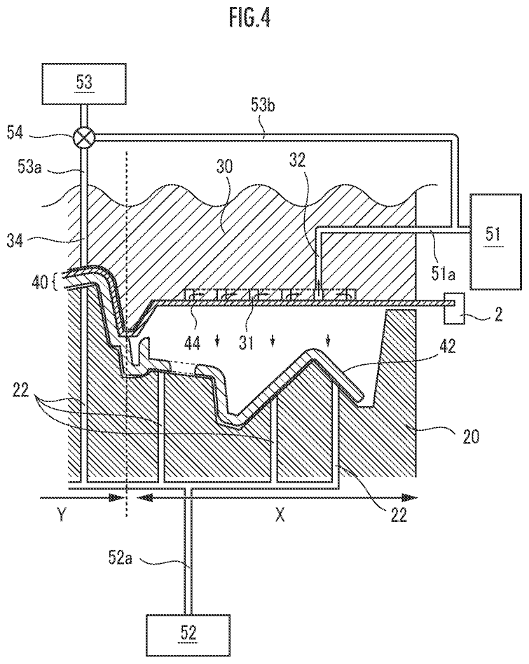

At this time, as indicated by non-bonding region X in FIG. 4, the control unit 61 sets the suction forces of the first suction device 51 and the second suction device 52 so that the suction force for sucking the sheet material 44 through the through-holes 32 becomes stronger than the suction force for sucking the workpiece body 42 through the suction holes 22. By setting the suction forces in this manner, the sheet material 44 of the unbonded portion can be appropriately drawn to the second mold 30.

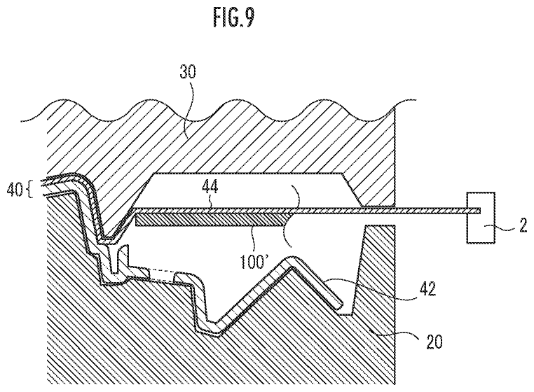

As described above, since the unbonded portion positioned at the peripheral edge of the workpiece body 42 is sucked by the first suction device 51 through the through-holes 32, as illustrated in FIG. 9 as a comparative example, it is not necessary to provide a shutter device 100′ for preventing bonding of the sheet material 44 at the peripheral edge of the workpiece body 42. Therefore, it is not necessary to arrange the clamps outside the shutter device 100′ so as to avoid the shutter device 100′ or prepare a wide sheet material 44, and the amount of the waste part of the sheet material 44 can be reduced and the manufacturing cost for the stacked workpiece 40 can be suppressed. Further, the installation cost of the shutter device 100′ and the maintenance cost of the shutter device 100′ are not incurred, and the cost of the stacked workpiece molding device 1 can be suppressed.

Further, assuming that the mold-side projection 20a and the workpiece-side projection 42a are not provided, when the sheet material 44 is separated from the second mold 30 by supplying the gas to the surface of the sheet material 44 from the gas supply device 53 through the ejection holes 34 in the bonding step of bonding the sheet material 44 to the workpiece body 42, when the gas supplied to the surface of the sheet material 44 flows directly into the through-holes 32 and is sucked by the first suction device 51, the sheet material 44 suction performance by the first suction device 51 deteriorates.

Therefore, in the present embodiment, as described above, when the mold-side projection 20a and the workpiece-side projection 42a are provided so as to surround the through-holes 32, it is possible to suppress or prevent the gas supplied from the gas supply device 53 to the surface of the sheet material 44 from flowing into the through-holes 32, and it is possible to suppress or prevent the deterioration of the sheet material 44 suction performance by the first suction device 51. Note that, instead of the mold-side projection 20a and the workpiece-side projection 42a, the mold-side projection may be provided on the second mold 30.

Further, since the through-holes 32 are opened into the net-shaped groove portions 31 provided on the inner surface of the second mold 30, a wide area where the groove portions 31 are provided can be sucked by the first suction device 51 through one through-hole 32, and the number of through-holes 32 per unit area of the inner surface of the second mold 30 can be reduced. Note that although the net-shaped groove portions 31 have been described in the present embodiment, the shape of the groove portions of the present invention is not limited to the net shape. For example, the groove portion may be formed in other shapes such as a straight shape, an H-shape, a C-shape, an X-shape, and a spiral shape.

### REFERENCE SIGNS LIST

1 stacked workpiece molding device
2 clamp
20 first mold
20a mold-side projection
22 suction hole
30 second mold
31 groove portion
32 through-hole
34 ejection hole
36 recess
40 stacked workpiece
42 workpiece body
42a workpiece-side projection
44 sheet material
51 first suction device
51a first connection pipe
52 second suction device
52a second connection pipe
53 gas supply device
53a third connection pipe
53b bypass path
54 flow path switching valve
61 control unit
100′ shutter device
X non-bonding region
Y bonding region

1. A stacked workpiece molding device comprising:
a first mold configured to suck and hold a workpiece body; and
a second mold configured to have on an inner surface a pattern that can be transferred to a surface of a sheet material stacked on the workpiece body and press the sheet material against the workpiece body, wherein
the inner surface of the second mold includes a groove portion that is positioned at a peripheral edge portion of the workpiece body,
the second mold includes a through-hole extending to open into the groove portion,
the through-hole is connected to a first suction device that sucks the sheet material,
the first mold includes a suction hole for sucking the workpiece body, and
the suction hole is connected to a second suction device.

2. The stacked workpiece molding device according to claim 1, wherein the groove portion is provided in a net shape.

3. The stacked workpiece molding device according to claim 1, comprising:
a control unit configured to set suction forces of the first suction device and the second suction device, wherein
the control unit sets the suction force of the first suction device to be stronger than the suction force of the second suction device in a bonding step of bonding the sheet material to the workpiece body.

4. The stacked workpiece molding device according to claim 2, comprising:
a control unit configured to set suction forces of the first suction device and the second suction device, wherein
the control unit sets the suction force of the first suction device to be stronger than the suction force of the second suction device in a bonding step of bonding the sheet material to the workpiece body.
